(19) United States
(12) Patent Application Publication
(10) Pub. No.: US 2006/0200318 A1
(43) Pub. Date: Sep. 7, 2006

(54) Estimation method of fluorescent dye's concentration from multiple fluorescence and the estimation method of fluorescent intensity from multiple fluorescence

(75) Inventors: So-ichiro Morishita, Wako-shi (JP); Hideo Yokota, Wako-shi (JP); Ryutaro Himeno, Wako-shi (JP); Taketoshi Mishima, Wako-shi (JP)

Correspondence Address: BIRCH STEWART KOLASCH & BIRCH, PO BOX 747, FALLS CHURCH, VA, 22040-0747, US

(73) Assignee: RIKEN, Wako-shi (JP)

(21) Appl. No.: 11/218,466

(22) Filed: Sep. 6, 2005

(30) Foreign Application Priority Data
Mar. 7, 2005 (JP) 2005-062524

(51) Int. Cl. G06F 19/00; G01N 31/00

(52) U.S. Cl. 702/20; 702/22

(57) ABSTRACT

It is an object of the invention to provide an estimation method of fluorescent dye's concentration from multiple fluorescence, where the accurate estimation of the fluorescent dye's concentration of each fluorescent dye from multiple fluorescence is made possible and the separation of multiple fluorescence which is difficult in the prior art is made possible. In the estimation method of fluorescent dye's concentration from multiple fluorescence where the fluorescent dye's concentration from measured multiple fluorescence, independent component analysis is performed to the spectrum of fluorescent dye where fluorescent dye's concentration is known to derive the intensity of an independent component, regression analysis is performed by using the derived intensity of the independent component as a variable to estimate the fluorescent dye's concentration function of the fluorescent dye where the fluorescent dye's concentration is known, and the concentration of fluorescent dye is estimated from the measured multiple fluorescence based on the estimated fluorescent dye's concentration function.

### BACKGROUND OF THE INVENTION

1. Field of the Invention

The present invention relates to the estimation method of fluorescent dye's concentration from multiple fluorescence and the estimation method of fluorescent intensity from multiple fluorescence, more particularly to the estimation method of fluorescent dye's concentration from multiple fluorescence and the estimation method of fluorescent intensity from multiple fluorescence, which are preferably used for multiple fluorescence imaging or the like. Particularly, the invention relates to the estimation method of fluorescent dye's concentration from multiple fluorescence and the estimation method of fluorescent intensity from multiple fluorescence, which are preferably used in separating multiple fluorescence being superposed fluorescence in the multiple fluorescence imaging or the like.

2. Description of the Related Art

Conventionally, there is known the fact that, when light is irradiated on fluorescent dye, fluorescence having a wavelength different from the wavelength of the light (excitation light) irradiated onto the fluorescent dye is observed.

Specifically, the fluorescent dye is excited by absorbing photon, and it loses energy due to intramolecular relaxation to emit photon having lower energy than the absorbed photon. This phenomenon is called fluorescence, and the fluorescence is observed as light having lower energy than the excitation light, which is light having a long wavelength as described.

In more detail, each fluorescent dye has intrinsic absorption spectrum ε(λ) and emission spectrum f(λ), and the peak of absorption spectrum ε(λ) is referred to as excitation wavelength and the peak of emission spectrum f(λ) is referred to as fluorescence wavelength.

Therefore, with such property of the fluorescent dye, it is possible to observe only the distribution of fluorescent dye in a sample containing fluorescent dye by irradiating light, which contains excitation wavelength but does not contain fluorescence wavelength, onto the sample and by observing only fluorescent dye.

As described, fluorescence is observed at a different wavelength from the wavelength of excitation light, so that its presence in the sample can be easily discriminated without suffering from scattered light or transmitted light.

With the above-described background, fluorescence imaging that is a method in which protein or living tissue is stained and visualized by fluorescent dye, for identifying protein or observing living tissue is widely performed in the field of molecular biology or the like.

In other words, since fluorescent dye emits fluorescence in a different wavelength from that of excitation light as described, it is possible to take out only fluorescence by properly combining wavelength filters, for example, and to observe the distribution or the shape of only tissue stained by fluorescent dye. Therefore, in observing a living body shape, the fluorescence imaging where tissue to be observed is marked by fluorescent dye is recognized to be effective, and it is widely performed in the field of molecular biology or the like for identifying protein or observing living tissue.

Further, among the above-described fluorescence imaging, the visualizing method where multiple fluorescent staining is performed using a plurality of fluorescent dye is referred to as multiple fluorescence imaging. With the achievement of research in today's fluorescent dye synthesis and marking technology, multiple fluorescent staining where various types of tissue of a sample are stained by different fluorescent dye is feasible, and the above-described multiple fluorescence imaging is today's mainstream of observation.

Meanwhile, in observing a multiple fluorescent staining sample in the multiple fluorescence imaging, superposed fluorescence needs to be separated.

To simplify the separation of fluorescence in the multiple fluorescent staining, it is necessary to combine various types of fluorescent dye not to allow the excitation wavelength and the fluorescence wavelength of a fluorescent dye to fall on those of another fluorescent dye.

Herein, assuming that the absorption spectrum of fluorescent dye i be εᵢ(λ) and the emission spectrum of fluorescent dye j be fⱼ(λ), mutual influence r (i, j) between absorption spectrum of fluorescent dye i and emission spectrum of fluorescent dye j can be calculated as follows.

$$r ( i , j ) = \{ \begin{matrix}0 , & for i = j \\ \int {ɛ}_{i} ( λ ) {f}_{j} ( λ ) ⅆ λ , & for i \neq j\end{matrix} \qquad ( 1 )$$

Assuming that the number of fluorescent dye used in staining be N, the mutual influence between fluorescent dye is expressed as follows.

$$R = {\sum }_{i = 1}^{N} {\sum }_{j = 1}^{N} r ( i , j ) \qquad ( 2 )$$

At this point, the synthesis of fluorescent dye where R of expression (2) becomes as small as possible is optimum in separating fluorescence in the multiple fluorescence imaging.

However, since the absorption spectrum and the emission spectrum have a certain width, it is extremely difficult to bring the mutual influence to 0 (zero), that is, to obtain the synthesis of fluorescent dye having no mutual influence at all, and the synthesis of fluorescent dye having mutual influence of a negligibly sufficiently small level is very limited.

For this reason, as a separating method of superposed fluorescence in the multiple fluorescence imaging, various types of separating method of multiple fluorescence where the mutual influence between fluorescence dye is taken in consideration have conventionally been suggested.

As such a conventional separating method of multiple fluorescence, a measurement method of the intensity of specific wavelength using wavelength filters, an estimation method of fluorescent intensity from spectrum using linear unmixing, and the like are known, for example.

Herein, formulation of fluorescence observation will be discussed for easy understanding of the explanation below. Firstly, to formulate fluorescence observation, an observation system capable of dispersing excitation light and observation light into spectrum is considered.

Spectrum X obtained by observing a sample using the observation system is expressed below as the function of excitation wavelength λ_{I} and observation wavelength λ_{O}.
X(λ_{I},λ_{O})=E(λ_{I},λ_{O})S(λ_{I},λ_{O}) (3)

It is to be noted that, in expression (3), E denotes an equipment function determined by the light source of the observation system, an optical system or a detector, and S denotes a sample function determined by the property of the sample.

The sample function S is expressed as the sum of Sᵣ, which expresses only component scattered by the sample, and S_{f}, which expresses component derived from fluorescence, as shown in the following expression (4).
S(λ_{I},λ_{O})=Sᵣ(λ_{I},λ_{O})+S_{f}(λ_{I},λ_{O}) (14)

Meanwhile, in expression (4), Sr is unnecessary component in observing fluorescence and it is rather regarded as noise. However, because scattered light is never observed in a wavelength other than the wavelength of excitation light, the following expression holds.
(Sᵣ(λ_{I},λ_{O})=0|λ_{I}≠λ_{O})) (5)

Therefore, the following expression is obtained from expression (3), expression (4) and expression (5).
(X(λ_{I},λ_{O})λλ_{I}≠λ_{O})=S_{f}(λ_{I},λ_{O}) (6)

In other words, the case where excitation wavelength and observation wavelength are not equal may be considered in order to observe fluorescence, which is the essence of fluorescence observation, and both of the above-described method of wavelength selection by wavelength filters and the method by linear unmixing are based on this concept.

Next, a conventional method of wavelength selection by wavelength filters will be described, and the separation of fluorescence using the wavelength selection using wavelength filters is known as a reliable and simple method in staining by single fluorescent dye and also multiple fluorescence staining where excitation wavelength and fluorescence wavelength between fluorescent dye are sufficiently different by a large amount.

Herein, assuming that the spectral transmittance of a wavelength filter on the excitation light side be F_{I} and the spectral transmittance of a wavelength filter on the observation light side be F_{O}, observed value X can be expressed by the following expression (7).
X(λ_{I},λ_{O})=∫∫F_{I}(λ_{I})F_{O}(λ_{O})E(λ_{I},λ_{O})S(λ_{I},λ_{O})dλ_{I}dλ_{O} (7)

However, to satisfy the condition of expression (6), the combination of wavelength filters should be selected such that F_{I} and F_{O} become orthogonal to each other, which is expressed as follows.
∫F_{I}(λ)F_{O}(λ)dλ=0

In the case of multiple fluorescent staining, wavelength filters must be selected to minimize the mutual influence between fluorescent dye.

Herein, assuming that amount Yᵢ expressing the fluorescence of fluorescent dye i, which is measured via F₁ and F₂, be as follows,
Yᵢ∫∫F₁(λ_{I})εᵢ(λ_{I})fⱼ(λ_{O})F_{O}(λ_{O})dλ_{I}dλ_{O} (8)
it is considered that the following calculation may be done regarding each fluorescent dye i.

$${R}_{i} = \frac{{\sum }_{j \vert j \neq i}^{N} {Y}_{j}}{{Y}_{i}} \qquad ( 9 )$$

And then, a combination of wavelength filters may be selected to make Rᵢ as small as possible.

As described, in the above-described conventional method of wavelength selection by wavelength filters, it is necessary to select wavelength filters not to allow the peaks of excitation wavelength and fluorescence wavelength to overlap on each other. There has been a problem that a suitable filter combination was not always obtained necessarily, but such a combination was rather very limited.

In other words, the conventional method of wavelength selection by wavelength filters has had a problem that it was impossible to separate and discriminate multiple fluorescence in the case of simultaneously using fluorescent dye whose peaks of absorption spectrum and emission spectrum were close.

In addition, the conventional method of wavelength selection by wavelength filters has had a problem that the maximum number of fluorescent dye that can be used simultaneously was about two to three types.

On the other hand, the separation of spectrum by linear unmixing is known to be effective in separating fluorescence whose peak wavelengths of absorption spectrum and emission spectrum are close (refer to Hiromichi Tsurui, “Hyper-multicolor fluorescence imaging method based on imaging spectrometry”, Cytometry Research, 9(2), pp. 1-7, 1999).

Specifically, linear unmixing is a method of separating multiple fluorescence from spectrum by spectrometric analysis, where either the excitation wavelength of excitation light or the observation wavelength of observation light is fixed, and the other wavelength of excitation light or observation light where the wavelength is not fixed is scanned to observe spectrum. Herein, fixing the wavelength of either excitation light or observation light means that the spectrum of either excitation light or observation light is not changed, and whether the light is light having single wavelength, white light, or light formed by mixing light having various kinds of wavelength is no object.

Meanwhile, for the purpose of describing expressions in a simplified manner in the explanation below, the wavelength of scanned light (excitation light or observation light) is defined simply as λ. λ is discrete wavelength, and should take values of L-pieces. Then, an L-dimension column vector where signal intensity of each wavelength is arranged is expressed as x.

Moreover, the number of fluorescence dye used in staining is N, is used as a reference, and spectrum where only fluorescent dye i (i=1, . . . , N) is fluorescent should be obtained as L-dimension column vector ai.

Herein, given that the fluorescence spectrum of mixed fluorescent dye is expressed by linear combination of reference aᵢ, relative intensity yᵢ of observed spectrum x to the reference aᵢ can be calculated as the projection of x onto aᵢ as follows.

$${y}_{i} = \frac{{}_{}^{T}{a}{}_{i}^{} x}{\vert {a}_{i} \vert} \qquad ( 10 )$$

In the above expression (10), ^{T} denotes transpose.

Meanwhile, for signal separation by linear unmixing, reference aᵢ should not necessarily be orthogonal but it may only be independent. It is a matter of course that the peak wavelengths of absorption spectrum and emission spectrum may be overlapped on each other.

In short, linear unmixing is a method in which the linear combination model of spectrum is presumed, the projection of observed spectrum to spectrum intrinsic to dye (the spectrum intrinsic to dye is referred to as “fingerprint”) based on the theory of linear algebra and separation is performed. According to this method, multiple fluorescence can be separated as long as only the shapes of spectrum are different even if the peaks of fluorescence are overlapped.

In the linear unmixing, however, the linear combination model of spectrum, which is the presumption of this method, is not established when an observation subject is fluorescence due to the mutual influence between fluorescence dye, and there has been a problem that the method was applicable only when the mutual influence between fluorescence dye was negligible and such state was very rare.

In other words, in the separation of multiple fluorescence, it is often the case where the linear combination model is not established due to the cause that the fluorescence of fluorescent dye is absorbed to be excited by another fluorescent dye. The linear unmixing is the method where the spectrum of fluorescence is observed to obtain the fluorescent intensity of each fluorescent dye from a linear map to the fluorescence spectrum of fluorescent dye as described above, which is the method based on the linear combination model of spectrum, so that there has been a problem that the application range of the method was limited.

Specifically, there has been a problem that the linear unmixing based on the linear combination model of spectrum was not applicable because the linearity of spectrum was not maintained when the excitation wavelength and the fluorescence wavelength of fluorescent dye were overlapped to each other.

Further, the linear unmixing is based on the assumption that the mutual influence between fluorescent dye does not occur, and the separation result of multiple fluorescence by this method is meaningless unless R is obtained in expression (2) is sufficiently small. However, since R obtained in expression (2) is likely to be larger as the number of fluorescent dye used in multiple fluorescent staining increases, there has been a problem that the number of fluorescent dye that can be rightly separated by this method was experientially about three at the most.

As described above, the conventional method of wavelength selection by wavelength filters and the method of linear unmixing can only be applied to limited cases because the mutual influence between fluorescent dye is not taken in consideration, so that they have a problem that they are not applicable when the excitation wavelength and the fluorescence wavelength of fluorescent dye were overlapped to each other to cause mutual influence, and there has also been a problem that the number of fluorescent dye that can be used simultaneously in multiple fluorescent staining was very small.

### OBJECTS AND SUMMARY OF THE INVENTION

The present invention has been created in view of the above-described various problems that the prior art has, and it is an object of the invention to provide an estimation method of fluorescent dye's concentration from multiple fluorescence, where the accurate estimation of the fluorescent dye's concentration of each fluorescent dye from multiple fluorescence is made possible and the separation of multiple fluorescence which is difficult in the prior art is made possible.

Further, it is an object of the invention to provide an estimation method of fluorescent dye's concentration from multiple fluorescence, where the accurate estimation of the fluorescent dye's concentration of each fluorescent dye from multiple fluorescence is made possible and the number of fluorescent dye that can be simultaneously used in multiple fluorescent staining is significantly increased comparing to the prior art.

Furthermore, it is an object of the invention to provide an estimation method of fluorescent intensity from multiple fluorescence, where the accurate estimation of the fluorescent intensity of each fluorescent dye from multiple fluorescence is made possible and the separation of multiple fluorescence which is difficult in the prior art is made possible.

Still further, it is an object of the invention to provide an estimation method of fluorescent intensity from multiple fluorescence, where the accurate estimation of the fluorescent intensity of each fluorescent dye from multiple fluorescence is made possible and the number of fluorescent dye that can be simultaneously used in multiple fluorescent staining is significantly increased comparing to the prior art.

To achieve the above-described objects, the present invention as a method having small influence by the mutual action between fluorescent dye is that a fluorescent dye's concentration function or a fluorescent intensity function is estimated by regression analysis from the spectrum in multiple fluorescence and the concentration or the fluorescent intensity of each fluorescent dye is estimated based on the estimation, by which multiple fluorescence can be separated.

More specifically, in the present invention, by performing regression analysis based on the spectrum of fluorescent dye whose mixture ratio of fluorescent dye used in multiple fluorescent staining, that is, concentration is known or the spectrum of fluorescent dye whose fluorescent intensity is known, the fluorescent dye's concentration function being the concentration function of each fluorescent dye or the fluorescent intensity function is estimated to spectrum and the concentration or fluorescent intensity of each fluorescent dye is estimated based on the estimated fluorescent dye's concentration function or the fluorescent intensity function, by which the separation of multiple fluorescence is made possible.

Herein, in the present invention, since spectrum has high co-linearity and it is difficult to apply regression analysis as it is, so that independent component analysis (ICA) is conducted to the spectrum to remove the co-linearity.

Further, a linear regression model or a logistic regression model being a non-linear regression model can be applied as a regression model used in the regression analysis in the present invention. Accuracy is reduced but calculation cost becomes small when the linear regression model is used, whereas accuracy is high but calculation cost becomes larger when the logistic regression model or the like being the non-linear regression model is used.

Specifically, according to the present invention, the independent component analysis and the regression analysis such as the logistic regression analysis are used as a determination method based on the non-linear model, the fluorescent dye's concentration function or the fluorescent intensity function from multiple fluorescence are found to estimate the fluorescent dye's concentration or the fluorescent intensity, and multiple fluorescence is separated according to the estimation, so that the quantitative separation of fluorescence based on the fluorescent dye's concentration or the fluorescent intensity and the separation of fluorescence where the number of fluorescent dye is not limited can be realized.

In short, the present invention is a method in which a sample whose fluorescent dye's concentration or fluorescent intensity is known is prepared in advance, and the fluorescent dye's concentration function being a function for obtaining the concentration of each fluorescent dye from its spectrum or the fluorescent intensity function being a function for obtaining the fluorescent intensity of each fluorescent dye is found by regression analysis. Herein, although correlation immunity between explanatory variables is required in regression analysis, spectrum does not satisfy the requirement because of its high multiple co-linearity, so that the variables are contracted in advance by using independent component analysis that is a method of multivariate analysis. Then, linear or non-linear regression analysis is conducted by using the contracted variables as explanatory variables and the concentration or the fluorescent intensity of fluorescent dye as an explained variable, and the fluorescent dye's concentration function or the fluorescent intensity function is obtained for each dye. Consequently, as a regression model used for regression analysis, since the linear regression model has poor fitting although its calculation cost is low, it is preferable to apply the logistic regression model, which is a type of the non-linear regression model having high accuracy although its calculation cost is high, when high accuracy is required.

Specifically, the present invention is an estimation method of fluorescence dye's concentration from multiple fluorescence, where the fluorescent dye's concentration of each fluorescent dye is estimated from measured multiple fluorescence, in which independent component analysis is performed to the spectrum of fluorescent dye where fluorescent dye's concentration is known to derive the intensity of an independent component, regression analysis is performed by using the derived intensity of the independent component as a variable to estimate the fluorescent dye's concentration function of the fluorescent dye where the fluorescent dye's concentration is known, and the fluorescent dye's concentration of each fluorescent dye is estimated from the measured multiple fluorescence based on the estimated fluorescent dye's concentration function.

Further, the present invention is an estimation method of fluorescent intensity from multiple fluorescence, where the fluorescent intensity of each fluorescent dye is estimated from measured multiple fluorescence, in which independent component analysis is performed to the spectrum of fluorescent dye where fluorescent intensity is known to derive the intensity of an independent component, regression analysis is performed by using the derived intensity of the independent component as a variable to estimate the fluorescent intensity function of the fluorescent dye where the fluorescent intensity is known, and the fluorescent intensity of each fluorescent dye is estimated from the measured multiple fluorescence based on the estimated fluorescent intensity function.

Further, the present invention is a method in which the above-described regression analysis is regression analysis by a linear regression model.

Furthermore, the present invention is a method in which the above-described regression analysis is regression analysis by a non-linear regression model.

Still further, the present invention is a method in which the above-described non-linear regression model is a logistic regression model, a polynomial regression model, Fourier series, wavelet, or n-th spline.

Therefore, according to the present invention, it is possible to estimate the fluorescent dye's concentration or the fluorescent intensity of each fluorescent dye from multiple fluorescence with good accuracy, and the invention exerts an excellent effect that the separation of multiple fluorescence which is difficult in the prior art is made possible.

Further, according to the present invention, it is possible to estimate the fluorescent dye's concentration or the fluorescent intensity of each fluorescent dye from multiple fluorescence with good accuracy, and the invention exerts an excellent effect that the number of fluorescent dye that can be simultaneously used in multiple fluorescent staining is significantly increased comparing to the prior art.

Then, the present invention can be used for identifying protein or observing living tissue in the field of molecular biology.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic constitution exemplary view of an experimental setup that was used in an experiment for proving the usefulness of the estimation method of fluorescent dye's concentration from multiple fluorescence according to the present invention;

FIG. 2 is a partially enlarged exemplary view of FIG. 1, where an area around a cuvette holder is shown;

FIG. 3 is a table showing primary specifications of a light source, an optical fiber, a sample cell and a detector out of modules constituting the experimental setup shown in FIG. 1 and FIG. 2;

FIG. 4 is a table showing the results of spectrum measurement performed to samples where dye A and dye B are mixed in different concentration ratio (dilution ratio and concentration ratio are in a reciprocal relation) by the experimental setup;

FIG. 5 is a table showing the results of spectrum measurement performed to samples where dye A and dye B are mixed in different concentration ratio (dilution ratio and concentration ratio are in a reciprocal relation) by the experimental setup;

FIG. 6 is a table showing the results of spectrum measurement performed to samples where dye A and dye B are mixed in different concentration ratio (dilution ratio and concentration ratio are in a reciprocal relation) by the experimental setup;

FIG. 7 is a table showing the results of spectrum measurement performed to samples where dye A and dye B are mixed in different concentration ratio (dilution ratio and concentration ratio are in a reciprocal relation) by the experimental setup;

FIG. 8 is a table showing the results of spectrum measurement performed to samples where dye A and dye B are mixed in different concentration ratio (dilution ratio and concentration ratio are in a reciprocal relation) by the experimental setup;

FIG. 9 is a table showing the results of spectrum measurement performed to samples where dye A and dye B are mixed in different concentration ratio (dilution ratio and concentration ratio are in a reciprocal relation) by the experimental setup;

FIG. 10 is a table showing the results of spectrum measurement performed to samples where dye A and dye B are mixed in different concentration ratio (dilution ratio and concentration ratio are in a reciprocal relation) by the experimental setup;

FIG. 11 is a graph where independent component analysis was conducted to the spectrum of the tables shown in FIG. 4 to FIG. 10 to extract two lines of independent component and they were plotted on a plane while taking the intensity (c₁, c₂) of independent component severally on x-axis and y-axis, and the isoconcentration lines of dye A are shown in solid lines whereas the isoconcentration lines of dye B are shown in broken lines;

FIG. 12 shows the regression surface of dᵢ(x) and the plots of measurement values of dye A, which were obtained by the estimation method of fluorescent dye's concentration from multiple fluorescence according to the present invention, where c₁ and c₂ were taken severally on x-axis and y-axis and pᵢ(c) was taken on z-axis. FIG. 12 shows graphs, whose projection angles are changed for parallax, are arranged on right and left to realize naked-eye stereoscopic vision, and a stereoscopic image comes out by stereoscopic view by a cross-view method;

FIG. 13 shows the regression surface of dᵢ(x) and the plots of measurement values of dye B, which were obtained by the estimation method of fluorescent dye's concentration from multiple fluorescence according to the present invention, where c₁ and c₂ were taken severally on x-axis and y-axis and pᵢ(c) was taken on z-axis. FIG. 13 shows graphs, whose projection angles are changed for parallax, are arranged on right and left to realize naked-eye stereoscopic vision, and a stereoscopic image comes out by stereoscopic view by a cross-view method;

FIG. 14 is a table showing the calculation results of indices Q² of the predictive performance of the estimation method of fluorescent dye's concentration from multiple fluorescence according to the present invention and a conventional method; and

FIG. 15 is a table showing the separation results of a spectrum image (original image) of artificially created double fluorescence by using the dye's concentration function obtained by the estimation method of fluorescent dye's concentration from multiple fluorescence according to the present invention and the conventional method.

### DETAILED DESCRIPTION OF THE PREFERRED EMBODIMENTS

In the following, an embodiment example of the estimation method of fluorescent dye's concentration from multiple fluorescence and the estimation method of fluorescent intensity from multiple fluorescence according to the present invention will be described in details based on the attached drawings.

Meanwhile, it is known that the fluorescent dye's concentration and the fluorescent intensity are in a corresponding relation, and the estimation of fluorescent dye's concentration and the estimation of fluorescent intensity are recognized as an equivalent matter. Therefore, in the following description, the estimation method of fluorescent dye's concentration from multiple fluorescence according to the present invention will be mainly explained, and the estimation method of fluorescent intensity from multiple fluorescence according to the present invention will be explained supplementally.

In explaining the estimation method of fluorescent dye's concentration from multiple fluorescence according to the present invention, description will be made firstly for the dimensionality reduction by independent component analysis, and the independent component analysis (ICA) is a method for performing blind source separation.

Assuming that signals transmitted from N pieces of independent signal sources S=(s₁, . . . , SN) are mixed linearly by mixed matrix A and M (≧N) pieces of observed values X=(x₁, . . . , x_{M}), this model can expressed as follows.
X=AS (11)

In the independent component analysis, signal source S and mixed matrix A are estimated from observed value X using the independence of the signal source when S and A are unknown.

Originally, a model presumed by the independent component analysis does not fit the spectrum of fluorescence. It is because the spectrum of single fluorescent dye can be regarded as a signal source but the signals are not mixed linearly.

However, when the independent component analysis is conducted to an observed value that does not fit the model, the result still remains the same that an independent component contained in the observed value is extracted even though the observed value cannot be regarded as a signal source.

In the present invention, attention is paid to this property of independent component analysis and the independent component analysis is applied to remove the correlation between explanatory variables for regression analysis.

Next, the application of the above-described independent component analysis to spectrum will be described. In this embodiment, independent component analysis is applied for spectrum that was observed by fixing either the excitation wavelength of excitation light or the observation wavelength of observation light and scanning the other wavelength of excitation light or observation light where the wavelength was not fixed similar to the method of linear unmixing in order to simplify explanation for easier understanding of the present invention. Herein, fixing the wavelength of either excitation light or observation light means not changing the spectrum of either excitation light or observation light, and whether the light is light having single wavelength, white light, or light formed by mixing light having various kinds of wavelength is no object.

The wavelength of scanned light (excitation light or observation light) is defined simply as λ (λ is discrete wavelength), and should take values of L-pieces at the discrete wavelength. Further, the number of mixed fluorescent dye should be N.

Now, it is assumed that N types of fluorescent dye were mixed and spectrum xⱼ(λ) (j=1, . . . , M) was obtained on M pieces of observation points.

The L-dimension column vector where signal intensity of each wavelength is arranged is expressed as xⱼ, and all spectrum observed (hereinafter, referred to as “observed spectrum” appropriately) is expressed as X=(x₁, . . . , x_{M}) Independent component analysis is conducted to the observed spectrum X, the observed spectrum X is decomposed into N pieces of independent component vectors, and the N pieces of independent component vectors that has been extracted should be sᵢ(i=1, . . . , N). Assuming that total independent component be S=(s₁, . . . , SN) and the mixed matrix be A, matrix X is expressed as expression (11). S and A satisfying the expression is found by independent component analysis.

Therefore, the intensity c(x) of independent component that the spectrum x has can be calculated from independent component S as follows.
c(x)^{T}=Sx (12)

Next, description will be made for the estimation method of fluorescent dye's concentration function by regression analysis, and now, it is assumed that there are m pieces of known observed values as the mixture ratio of fluorescent dye.

The spectrum should be νₖ(λ) (k=1, . . . , m), which is expressed by L-dimension column vector νₖ, and the intensity of independent component is calculated as γₖ=c(νₖ). Furthermore, the concentration of fluorescent dye i, which is normalized into [0, 1] in each observed value, is expressed as δᵢₖ.

Subsequently, the fluorescent dye's concentration function to determine the concentration of each fluorescent dye i is to be found by regression analysis, and a regression model is defined as follows. It is to be noted that the difference of operational effect caused by the difference of each regression model will be described later.

The case of linear regression model
p=b₀+b_{1×1}+ . . . +b_{n×N}
The case of logistic regression model
p=1/[1+exp{−(b₀+b_{1×1}+ . . . +b_{N×N})}]

Then, regarding each fluorescent dye i, the coefficient (b₀, . . . , b_{N}) of regression model is determined by the maximum likelihood method. It is to be noted that (X₁, . . . , X_{N})=^{T}γₖ, p=δᵢₖ should hold.

Obtained coefficients are severally set as (bᵢ₀, . . . , b_{iN}), and function pᵢ(c) is determined as follows.

The case of linear regression model
pᵢ(c)=bᵢ₀+bᵢ₁c₁+ . . . +b_{iN}c_{N}
The case of logistic regression model
pᵢ(c)=1/[1+exp{−(bᵢ₀+bᵢ₁c₁+ . . . +b_{iN}c_{N})}]
where, c=^{T}(c₁, . . . , c_{N})

Fluorescent dye's concentration function dᵢ(x) is found as dᵢ(x)=pᵢ(c(x)) using pᵢ(c)

Using dᵢ(x) that has been obtained in the above-described processing, the concentration of fluorescent dye i in a sample having spectrum x can be obtained.

Next, out of the regression analysis, the logistic regression model being a non-linear regression model will be described.

Firstly, the logistic regression is a method of regression analysis applied for nonparametric data.

Specifically, assuming that a happening probability of an event be p, log{p/(1−p)} being the logarithm of its odds ratio p/(1−p) is called a logit. The logit that is expressed in the linear combination of N pieces of independent variable Xᵢ is a logistic model, which is expressed as follows.

$$log ( \frac{p}{1 - p} ) = {b}_{o} + {b}_{1} {χ}_{1} + … + {b}_{N} {χ}_{N} \qquad ( 13 )$$

The above-described expression is transformed to obtain the following logistic function.

$$p = \frac{1}{1 + exp \{ - ( {b}_{o} + {b}_{1} {χ}_{1} + … + {b}_{N} {χ}_{N} ) \}} \qquad ( 14 )$$

Herein, parameter bᵢ(i=0, . . . , N) can be found by the maximum likelihood method.

Although p was defined as probability due to the original meaning of logistic regression model, p may essentially be a value meaning anything as long as the value takes 0 to 1 and complies with expression (14).

In the embodiment, p is defined as a fluorescent dye's concentration value taking the value from 0 to 1, the fitting of a function expressing the concentration value of each fluorescent dye is performed to the logistic regression model.

Herein, the estimation method of a fluorescent dye's concentration function by logistic regression analysis will be described in more details.

Specifically, to find the fluorescent dye's concentration function for determining the concentration of each fluorescent dye i by logistic regression, the coefficient (b₀, . . . , b_{N}) of the logistic function of expression (14) is determined first by the maximum likelihood method regarding each fluorescent dye i. It is to be noted that (X₁, . . . , X_{N})=^{T}γₖ, P=δᵢₖ should hold.

Obtained coefficients are severally set as (bᵢ₀, . . . b_{iN}), and logistic function pᵢ(c) is determined as expression (15).

$${p}_{i} ( c ) = \frac{1}{1 + exp \{ - ( {b}_{i 0} + {b}_{i 1} {c}_{1} + … + {b}_{iN} {c}_{N} ) \}} \qquad ( 15 )$$

where, c=^{T}(c₁, . . . , c_{N})=c(x) holds.

The fluorescent dye's concentration function dᵢ(x) is expressed as follows using pᵢ(c).
dᵢ(x)=p(c(x)) (16)

Using the fluorescent dye's concentration function dᵢ(x) obtained in the above-described processing, the concentration of fluorescent dye i in a sample having spectrum x can be obtained.

In short, c(x) of observed spectrum x is obtained in order to make determination by using function dᵢ(x). Then, dᵢ(c (x)) of each fluorescent dye i is calculated and it is used as the concentration of fluorescent dye i, that is, the fluorescent intensity.

Next, description will be made for the result of experiment that was performed for accuracy evaluation of the concentration of fluorescent dye i, which is found as described above.

The method of accuracy evaluation in the experiment will be explained first. In the experiment, the jackknife method which is a type of a cross validation method was used to evaluate accuracy. The method is for performing evaluation where a sample for estimation and a sample for evaluation are alternately used when the number of data samples is small.

When the number of samples is n pieces, n−1 pieces of samples are used for regression analysis. Evaluation for error is performed by data that were not used for regression analysis. The evaluation is repeated for n times to obtain the sum of squares of error, and it is called a predicted residual sum of squares (PRESS).

$$PRESS = {\sum }_{k = 1}^{n} ( {\hat{d}}_{ik} - {δ}_{ik} ) \qquad ( 17 )$$

Herein, \hat{d}ᵢₖ expresses a value obtained by estimating a parameter excluding the k-th data and predicting a δᵢₖ value from the result.

Moreover, a value by normalizing PRESS using the dispersion of samples to obtain the difference of the normalized value from 1 is called Q² and it is used as the index of predictive performance.

$${Q}^{2} = 1 - \frac{PRESS}{{\sum }_{k = 1}^{n} ( {δ}_{ik} - {\overline{δ}}_{i} )} \qquad ( 18 )$$

Herein, \overline{δ}ᵢ expresses the average value Of δᵢₖ.

Since PRESS becomes 0 when a predicted value and an actual measurement value completely match, Q² becomes 1. By comparing these values, the estimation method of the fluorescent dye's concentration from multiple fluorescence according to the present invention can be evaluated quantitatively.

In the following, the details of experiment will be explained, and in order to verify the usefulness of the estimation method of the fluorescent dye's concentration from multiple fluorescence according to the present invention, an experiment was performed where the concentration of each fluorescent dye from spectrum which was obtained by measuring the mixed solution of two types of fluorescent dye, was estimated.

Experiment Conditions

Mixed solutions, where the concentration of two types of fluorescent dye (FITC, RITC) were changed, were prepared, and they were used as samples to measure the spectrum of their fluorescence. In the explanation and the drawings related to this experiment, FITC are expressed as “A” or “dye A” appropriately, and RITC are expressed as “B” or “dye B” appropriately.

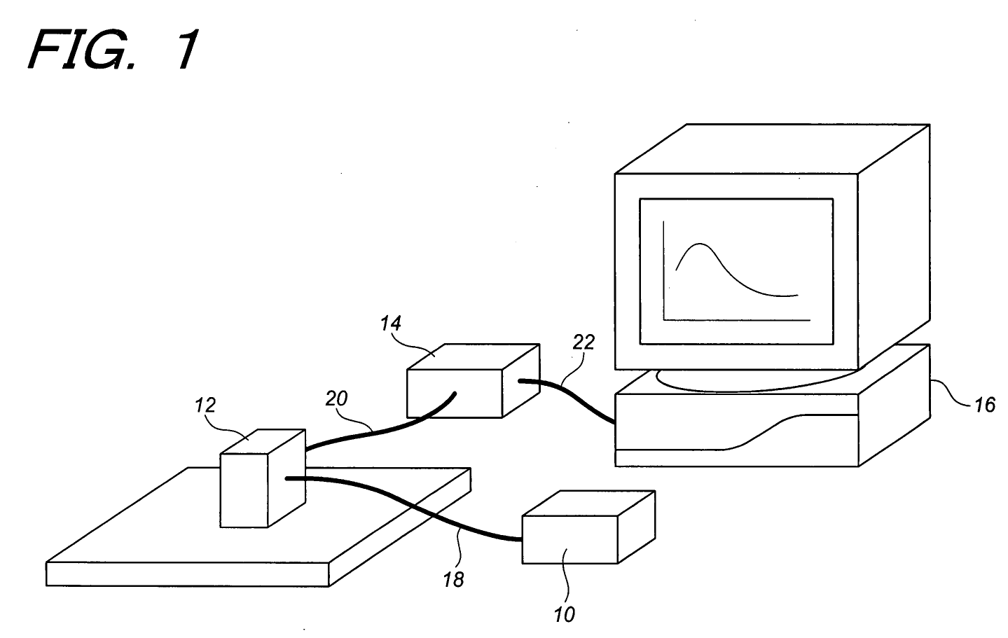

FIG. 1 shows the schematic constitution exemplary view of an experiment setup, and the experiment setup is constituted by having a light source 10, cuvette holder 12, a detector 14 equipped with a spectroscope therein, a personal computer 16 for acquiring data, an optical fiber 18 for guiding light between the light source 10 and the cuvette holder 12, an optical fiber 20 for guiding light between the cuvette holder 12 and the detector 14, and a cable 22 for transmitting data output from the detector 14 to the personal computer 16 for acquiring data.

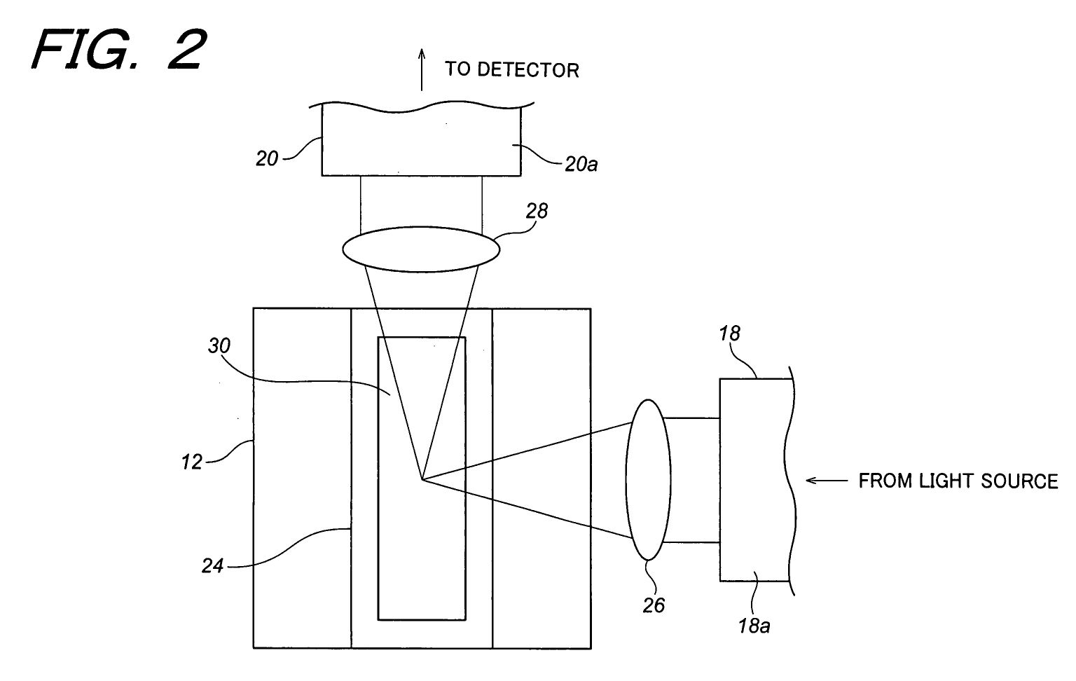

Further, FIG. 2 shows the partial enlarged exemplary view of FIG. 1, where an area around the cuvette holder 12 is shown, and a sample cell 24 for housing a sample 30 is provided for the cuvette holder 12.

Furthermore, a focusing lens 26 is provided between the cuvette holder 12 and the end portion 18a of the optical fiber 18, and a focusing lens 28 is provided between the cuvette holder 12 and the end portion 20a of the optical fiber 20. Both excitation light and observation light are focused on the central portion of the sample cell 24 by the focusing lenses (26, 28).

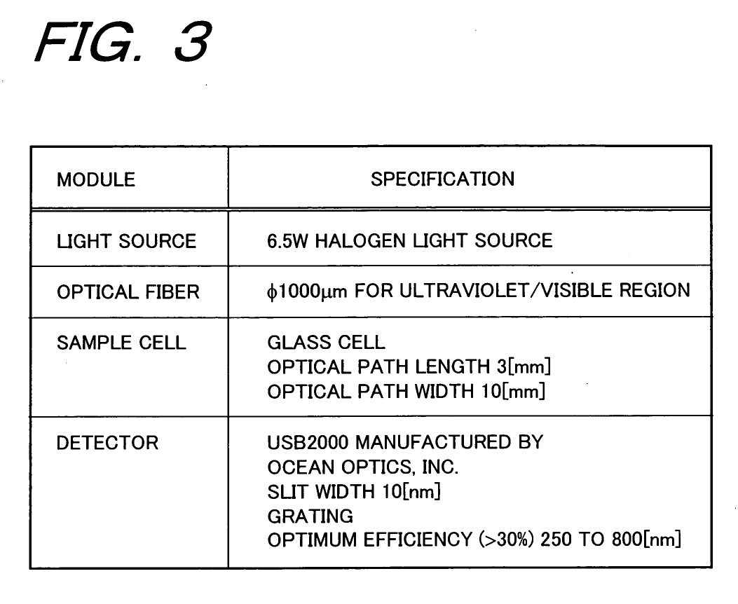

It is to be noted that the primary specifications of the light source 10, the optical fiber (18, 20), the sample cell 24, and the detector 14 are as shown in the attached table in FIG. 3.

In the experiment setup, light from the light source 10 is guided to the cuvette holder 12 by the optical fiber 18, and irradiated onto the sample 30 filled in the sample cell 24 of the cuvette holder 12. To observe only fluorescence, observation light is guided to the detector 14 by the optical fiber 20 arranged in the perpendicular direction to the optical axis of excitation light. Observation light is dispersed into spectrum by the spectroscope inside the detector 14, and the intensity of each wavelength is measured. Measured values are transmitted from the detector 14 to the personal computer 16 for acquiring data via the cable 22, and accumulated in the personal computer 16 for acquiring data.

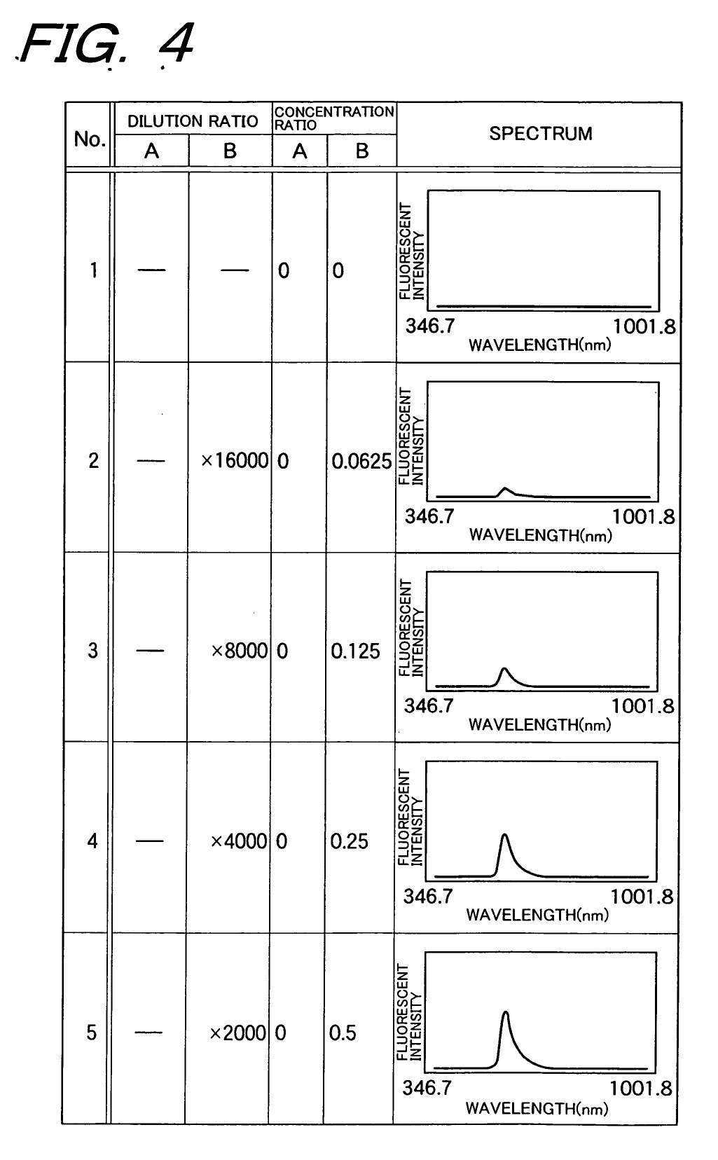

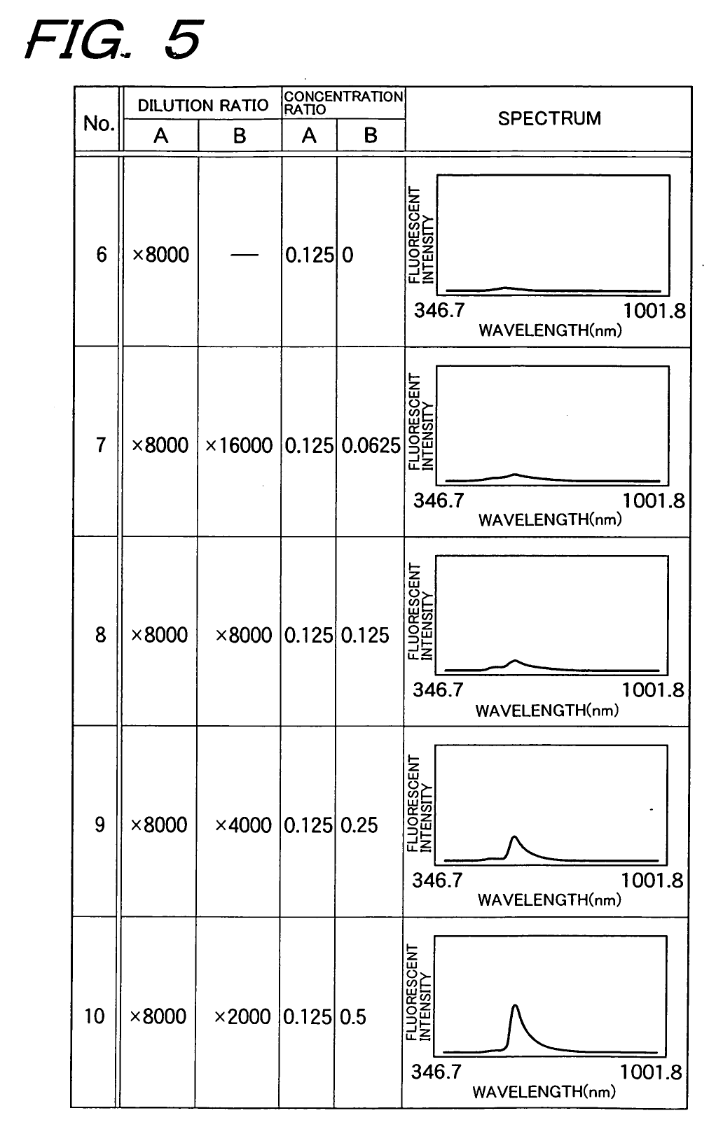

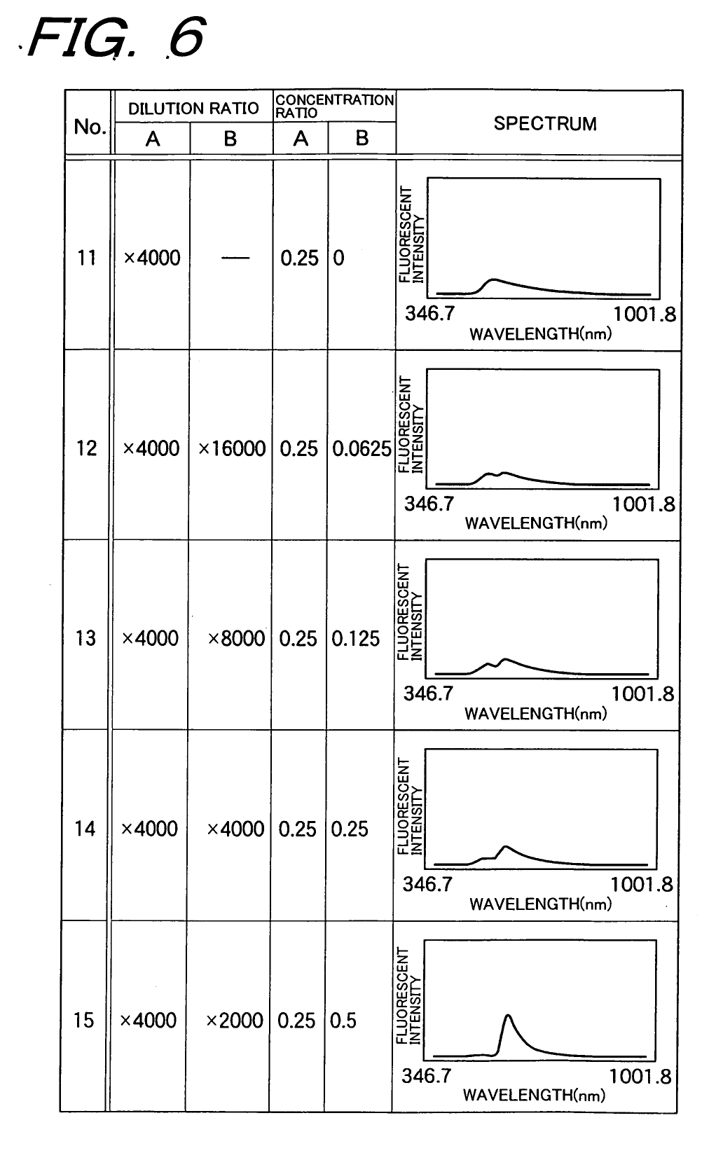

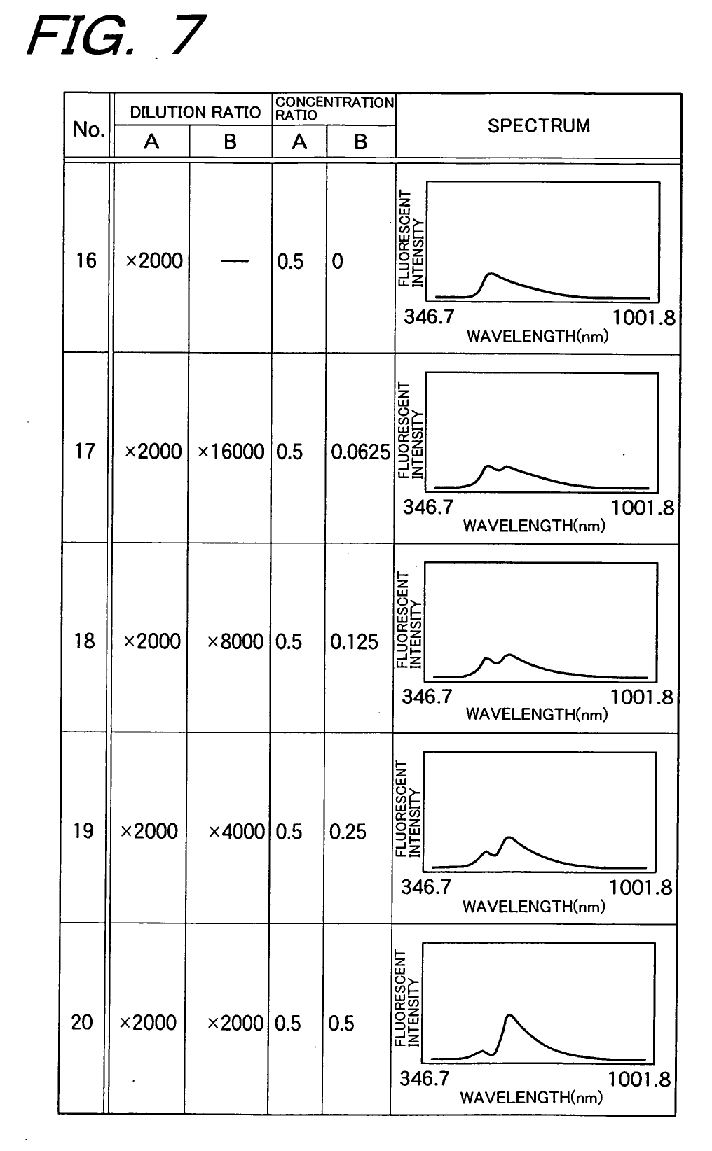

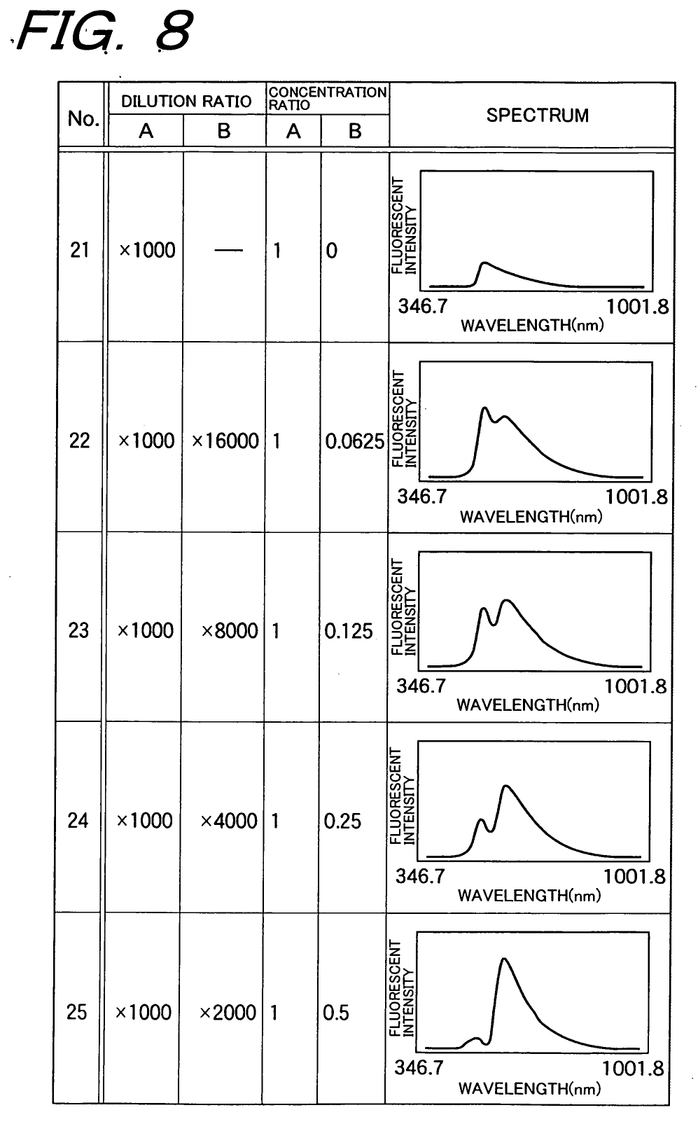

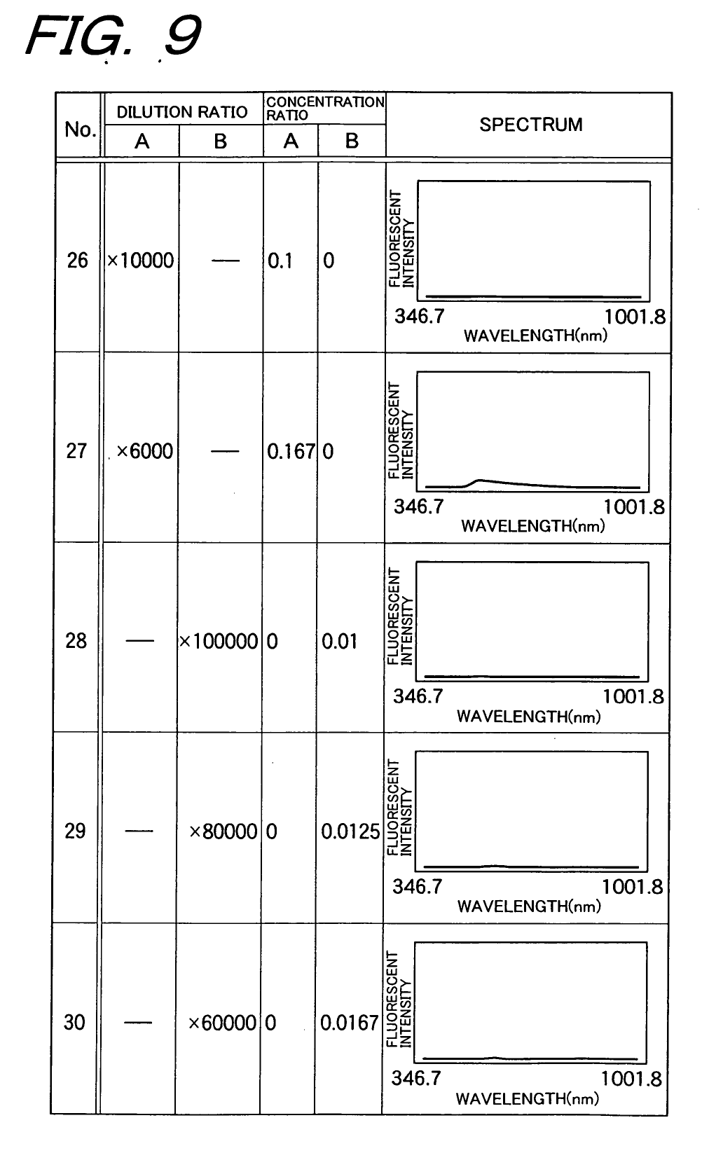

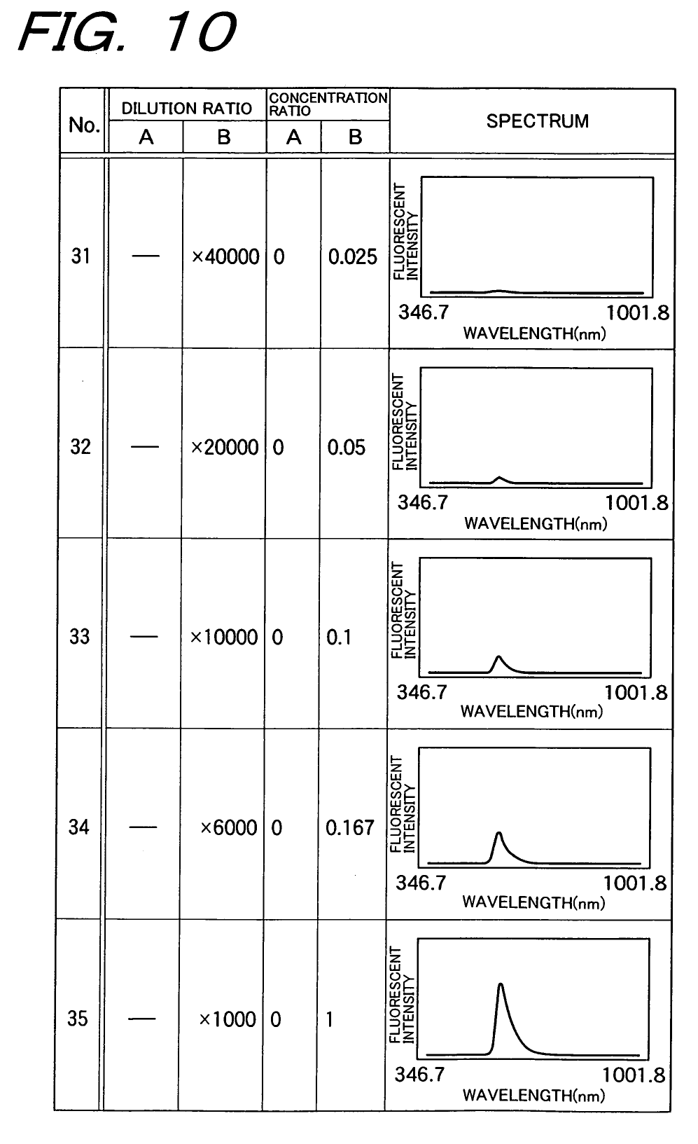

Herein, FIG. 4 to FIG. 10 severally show the results of spectrum measurement in the tables, which were performed to mixed samples of dye A and dye B having 35 types of concentration ratio (dilution ratio and concentration ratio are in a reciprocal relation) by the above-described experimental setup. Meanwhile, the concentration of dye A and dye B is their relative concentration to the concentration of water solution 1000 times DMSO in which dye A and dye B are severally dissolved, which is set to 1.

Further, in measuring spectrum, 2048 points between 346.7 to 1001.8 nm were measured at equal gap. Therefore, the numeric value of each parameter in each of the above-described expression is N=2, L=2048, M=35 and m=35 in the experiment.

Meanwhile, in the experiment setup, excitation light is not dispersed into spectrum and observation light inevitably contain excitation light, so that the observation system does not strictly satisfy the conditions of expression (6) that is necessary in separating fluorescence. However, looking at the spectrum (No. 1 in FIG. 4) obtained by observing only distilled water, the spectrum of light source 10, which should be observed as scattered light, cannot be identified. This shows that the scattered light of solvent is weak comparing to the fluorescence of dye A and dye B or the noise of the detector 14. In addition, characteristic spectrum showing the scattered light of dye A and dye B was not identified as well. Consequently, the influence of scattered light, which is caused by the fact that observed wavelength contains excitation wavelength, is considered to be negligible in this experiment.

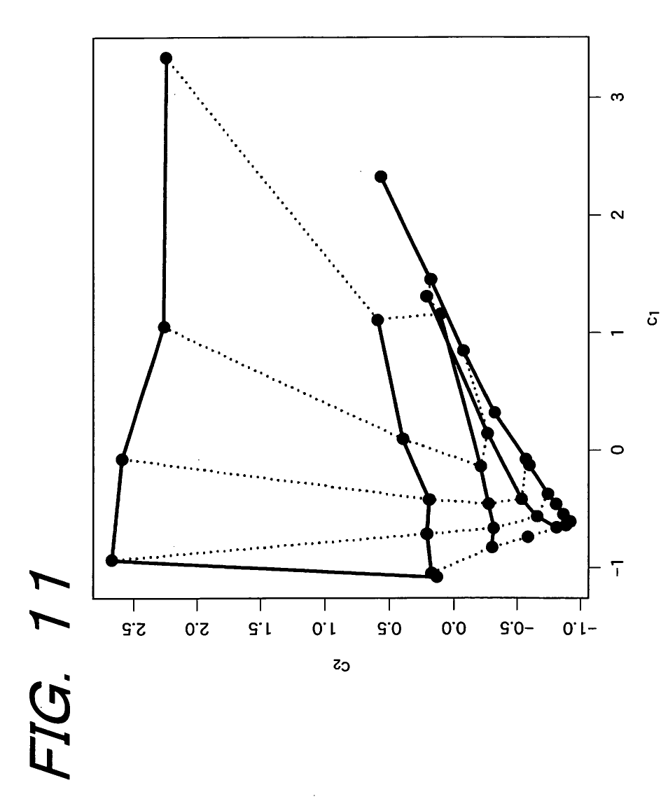

Next, description will be made for dimensionality reduction of spectrum, and FIG. 11 is the graph where independent component analysis was conducted to the spectrum of the tables shown in FIG. 4 to FIG. 10 to extract two lines of independent component and they were plotted on a plane while taking the intensity (c₁, c₂) of independent component severally on x-axis and y-axis. It is to be noted that the isoconcentration lines of dye A are shown in solid lines whereas the isoconcentration lines of dye B are shown in broken lines.

FIG. 11 showed the tendency that the isoconcentration lines of dye A extended horizontally. This means that the concentration of dye A is substantially equal when c₂ is equal, and it is possible to regard intensity c₂ as an amount roughly showing the concentration of dye A. On the other hand, the figure showed the tendency that the isoconcentration lines of dye B extended vertically, and it is possible to regard intensity c₁ as an amount roughly showing the concentration of dye B.

However, since the relationship between the intensity of independent component and dye's concentration is not clear, it is necessary to estimate the fluorescent dye's concentration function by regression analysis using the intensity of independent component as a variable.

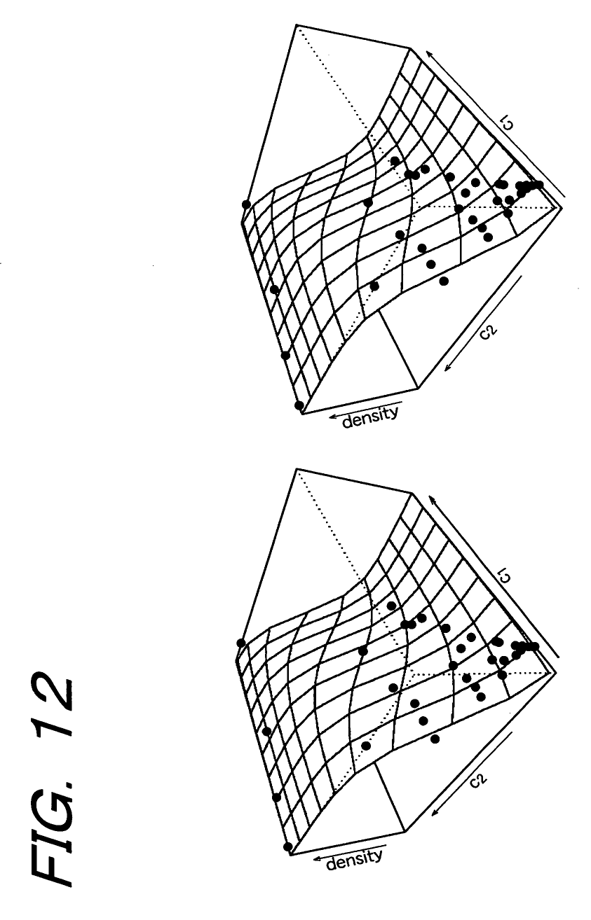

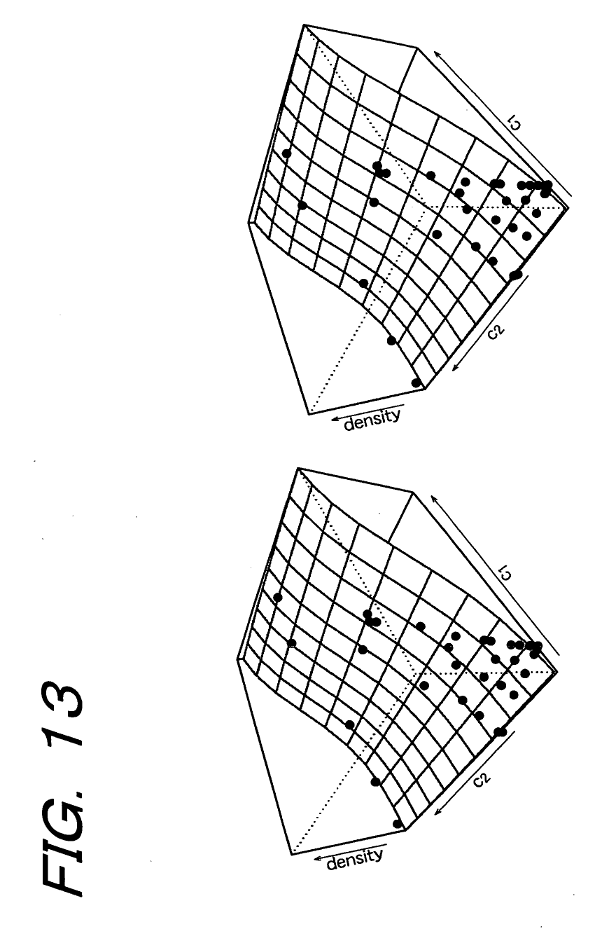

Next, description will be made for the estimation of fluorescent dye's concentration function by regression analysis, and FIG. 12 shows the regression surface of dᵢ(x) and the plots of measurement values of dye A, which were obtained by the estimation method of fluorescent dye's concentration from multiple fluorescence according to the present invention, and FIG. 13 shows the regression surface of dᵢ(x) and the plots of measurement values of dye B, which were obtained by the estimation method of fluorescent dye's concentration from multiple fluorescence according to the present invention. It is to be noted that c₁ and c₂ were taken severally on x-axis and y-axis and pᵢ(c) was taken on z-axis, in FIG. 12 and FIG. 13.

As shown in FIG. 12 and FIG. 13, the measurement values match the regression surface well, and the logistic regression model is a suitable method for the estimation of fluorescent dye's concentration from multiple fluorescence.

Meanwhile, FIG. 12 and FIG. 13 show graphs, whose projection angles are changed for parallax, which are arranged on right and left to realize naked-eye stereoscopic vision, and a stereoscopic image comes out by stereoscopic view by a cross-view method.

Herein, the cross-view method performs stereoscopic view by viewing a left image by right eye and viewing a right image by left eye. More specifically, looking at the images from the distance of about 1 foot, you gradually cross your eyes as if you look at your nose to make the right and left images overlap on each other. At this point, you should look three images arranged horizontally and a stereoscopic image should come out from paper when you keep your eyes on a central image.

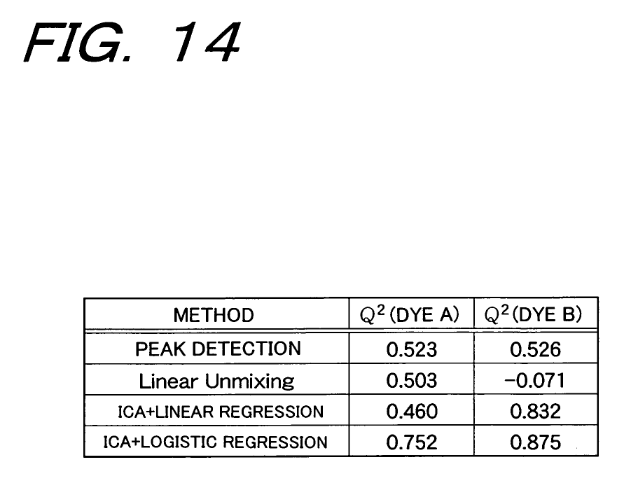

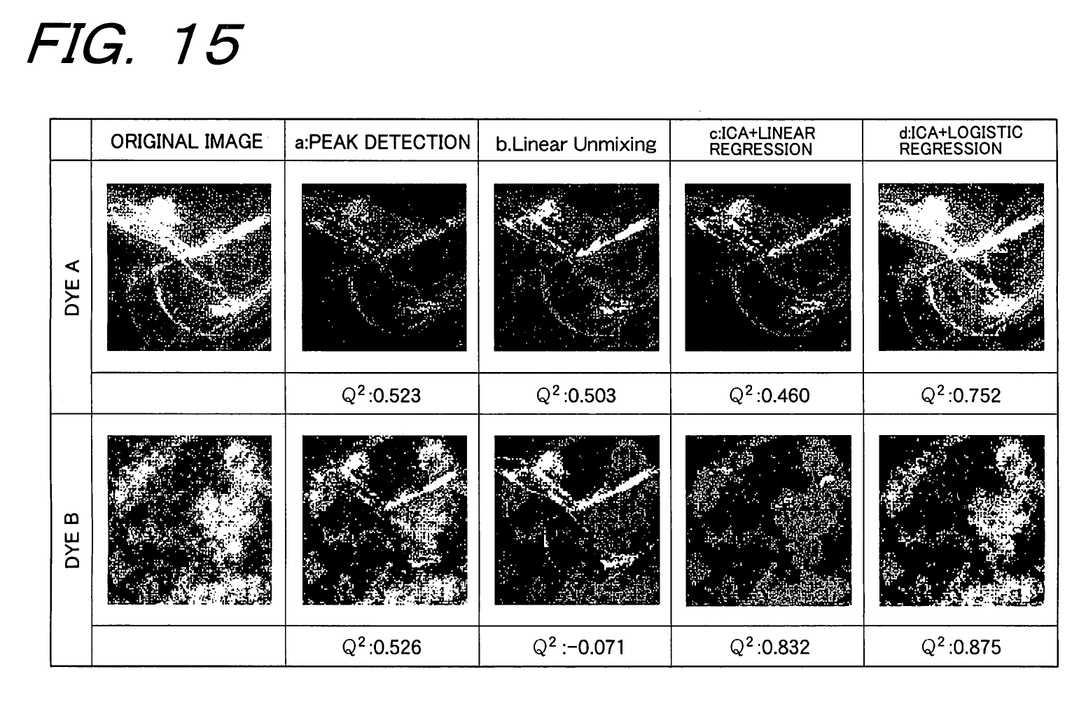

Next, the calculation of predictive accuracy and the visualization by artificial images. To perform quantitative evaluation of the estimation method of fluorescent dye's concentration from multiple fluorescence by the present invention, indices Q² of the predictive performance of the estimation method of fluorescent dye's concentration from multiple fluorescence according to the present invention and a conventional method were calculated. FIG. 14 shows the results on the table. In FIG. 14 and FIG. 15 (described later), “Peak detection” and “Linear unmixing” are the conventional methods, and “ICA+Linear regression”, that is, a method using independent component analysis and linear regression analysis, and “ICA+Logistic regression”, that is, a method using independent component analysis and logistic regression analysis are the estimation methods of fluorescent dye's concentration from multiple fluorescence according to the present invention.

Furthermore, FIG. 15 shows the separation results of a spectrum image (original image) of artificially created double fluorescence by using the dye's concentration function obtained by the estimation method of fluorescent dye's concentration from multiple fluorescence according to the present invention and the conventional method. In FIG. 15, the upper views are images showing the estimated dye's concentration of dye A and the lower views are images showing the estimated dye's concentration of dye B. It is to be noted that black and white images showing dye's concentration are actually obtained as shown in FIG. 15, but they may be shown in color images for easier view.

In FIG. 14 and FIG. 15, Q² denotes a value obtained by subtracting a normalized squared error from 1, and it is an amount not exceeding 1. The closer the value to 1, the higher the estimated accuracy. By the way, cross validation is employed in evaluating error when dye's concentration function is found by regression analysis (“ICA+Linear regression” and “ICA+Logistic regression” in FIG. 14 and FIG. 15).

It is to be noted that the process of creating artificial fluorescence images shown in FIG. 15 is as shown in the following procedure 1 to 5.

Procedure 1: Creating independent images for showing the concentration of dye A and dye B

Procedure 2: Overlapping the images to create an image having concentration ratio for each pixel

Procedure 3: Determining spectrum corresponding to each pixel based on FIG. 4 to FIG. 10

Procedure 4: Estimating concentration for each pixel by using each method regarding the spectrum as unknown

Procedure 5: Reconstructing a concentration image of each dye based on the estimated concentration

Although images created from the estimated results are actually black and white images showing dye's concentration, they may be shown in color images for easier view.

As described above, the peak detection corresponds to wavelength selection by wavelength filters, where the intensity of fluorescence wavelength is regarded as the strength of fluorescence. The result of dye A is dark in entire image, and it is believed that the fluorescence of dye A is absorbed into dye B. Further, the result of dye B shows that the dye is not separated from the fluorescence of dye A.

Furthermore, the linear unmixing had a lower Q² value than that of the peak detection. This shows that the synthesis of dye in this experiment was not suitable for the linear combination model of spectrum. The result is not reliable at all when the linear unmixing is applied for such a case.

On the other hand, when the linear regression is conducted to the result of independent component analysis, relatively high discrimination performance was obtained for dye B. One reason is that an independent component became an index showing the concentration of dye B as explained in the above-described dimensionality reduction of spectrum.

The result obtained by conducting the logistic regression to the result of independent component analysis achieved the best predictive performance. This shows that the logistic regression model is suitable for the relationship between explanatory variables and concentration obtained in independent component analysis.

As described above, by estimating the concentration of fluorescent dye by the estimation method of fluorescent dye's concentration from multiple fluorescence according to the present invention, multiple fluorescence can be separated and problems of the conventional methods could be solved. Particularly, the linear unmixing that is believed to be more useful than the wavelength selection by wavelength filters, because it analyzes spectrum, has limited applicable synthesis of dye due to the mutual influence of dye, but the present invention uses a method of estimating concentration function by using the independent component analysis and the regression analysis such as logistic regression analysis, so that it does not depend on the mutual influence between fluorescent dye.

In the foregoing, description has been made for the estimation method of fluorescent dye's concentration from multiple fluorescence according to the present invention, and the estimation method of fluorescent intensity from multiple fluorescence according to the present invention will be described.

Herein, the fluorescent dye's concentration and fluorescent intensity are known to have corresponding relation with each other as described above, and the estimation of fluorescent dye's concentration and the estimation of fluorescent intensity are recognized as an equivalent matter.

Therefore, the estimation method of fluorescent dye's concentration from multiple fluorescence according to the present invention can be directly and entirely used for the estimation of fluorescent intensity as it is. In short, by reading “fluorescent dye's concentration” in the estimation method of fluorescent dye's concentration from multiple fluorescence according to the present invention as “fluorescent intensity”, a method capable of estimating the fluorescent intensity of each fluorescence from multiple fluorescence can be obtained.

It is to be noted that the above-described embodiments can be modified as (1) to (4) shown below.

(1) In the above-described embodiments, description has been made for the case where multiple fluorescence staining was performed by simultaneously using the two types (dye A and dye B) of fluorescent dye. However, the number of fluorescent dye that can be used in multiple fluorescence staining is not limited to two, it goes without saying that any number (three or more) of fluorescent dye can be used in multiple fluorescence staining, and it is possible to estimate the concentration of each fluorescent dye with good accuracy in such a case.

(2) In the above-described embodiments, description has been made mainly for the logistic regression model as a regression model used in regression analysis. However, it goes without saying that the regression model used in regression analysis is not limited to the logistic regression model, and the linear regression model or the like can be also used as described above.

Herein, regarding the regression model used in regression analysis in the present invention, different models may be properly used depending on conditions by taking the following characteristics in consideration.

[Characteristics of Linear Regression Model]

Lower estimation accuracy than logistic regression model Low calculation cost

No range limit in values of explained variable

[Characteristics of Logistic Regression Model]

High estimation accuracy

Slightly higher calculation cost than linear regression model Limited range of explained variable to [0, 1]

As described above, since the logistic regression model has slightly higher calculation cost but higher estimation accuracy, the logistic regression model should be applied generally. On the other hand, it is preferable to apply the linear regression model when priority is given to lower calculation cost than estimation accuracy.

It is to be noted that the range of explained variable.

(value showing concentration) is limited in the logistic regression model. For example, to the spectrum of dye having much higher concentration than the samples used in regression analysis, a value proportional to the concentration can be obtained in the linear regression model. However, it is impossible for the logistic regression model to obtain such a proportional value because the model has the upper limit of 1.

Therefore, there are cases where the linear regression model can estimate concentration with better accuracy when the dynamic range of concentration cannot be predicted at all.

(3) In the above-described embodiments, description has been made for the logistic regression model as a non-linear regression model. However, it goes without saying that the non-linear regression model is not limited to the logistic regression model, and a polynomial regression model, Fourier series, wavelet or n-th spline can be appropriately used, for example.

(4) The above-described embodiments and the modified examples shown above-described (1) to (3) may be appropriately combined.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No.2005-62524 filed on Mar. 7, 2005 including specification, claims, drawings and summary are incorporated herein by reference in its entirety.

What is claimed is:

1. An estimation method of fluorescence dye's concentration from multiple fluorescence, where the fluorescent dye's concentration of each fluorescent dye is estimated from measured multiple fluorescence, wherein
independent component analysis is performed to the spectrum of fluorescent dye where fluorescent dye's concentration is known to derive the intensity of an independent component,
regression analysis is performed by using said derived intensity of the independent component as a variable to estimate
the fluorescent dye's concentration function of the fluorescent dye where said fluorescent dye's concentration is known, and the fluorescent dye's concentration of each fluorescent dye is estimated from the measured multiple fluorescence based on said estimated fluorescent dye's concentration function.

2. The estimation method of fluorescence dye's concentration from multiple fluorescence according to claim 1, wherein
said regression analysis is regression analysis by a linear regression model.

3. The estimation method of fluorescence dye's concentration from multiple fluorescence according to claim 1, wherein
said regression analysis is regression analysis by a non-linear regression model.

4. The estimation method of fluorescence dye's concentration from multiple fluorescence according to claim 3, wherein
said non-linear regression model is any one of a logistic regression model, a polynomial regression model, Fourier series, wavelet, and n-th spline.

5. An estimation method of fluorescent intensity from multiple fluorescence, where the fluorescent intensity of each fluorescent dye is estimated from measured multiple fluorescence, wherein
independent component analysis is performed to the spectrum of fluorescent dye where fluorescent intensity is known to derive the intensity of an independent component,
regression analysis is performed by using said derived intensity of the independent component as a variable to estimate
the fluorescent intensity function of the fluorescent dye where said fluorescent intensity is known, and the fluorescent intensity of each fluorescent dye is estimated from the measured multiple fluorescence based on said estimated fluorescent intensity function.

6. The estimation method of fluorescent intensity from multiple fluorescence according to claim 5, wherein
said regression analysis is regression analysis by a linear regression model.

7. The estimation method of fluorescent intensity from multiple fluorescence according to claim 5, wherein
said regression analysis is regression analysis by a non-linear regression model.

8. The estimation method of fluorescent intensity from multiple fluorescence according to claim 7, wherein
said non-linear regression model is any one of a logistic regression model, a polynomial regression model, Fourier series, wavelet, and n-th spline.
